(19) United States
(12) Patent Application Publication
(10) Pub. No.: US 2003/0188087 A1
(43) Pub. Date: Oct. 2, 2003

(54) Smart multi-functional compound memory

(76) Inventors: Doung-Her Tsai, Hsinchu (TW); Hong-Ming Yang, Hsinchu (TW)

Correspondence Address: MARTINE & PENILLA, LLP, 710 LAKEWAY DRIVE, SUITE 170, SUNNYVALE, CA, 94085, US

(21) Appl. No.: 10/273,688

(22) Filed: Oct. 18, 2002

(30) Foreign Application Priority Data
Apr. 2, 2002 (TW) 91106680

(51) Int. Cl. G06F 12/00

(52) U.S. Cl. 711/104; 711/103

(57) ABSTRACT

The invention provides a smart multi-functional compound memory. The smart multi-functional compound memory includes a volatile memory, a nonvolatile memory and a data conversion circuit, and is packaged as a single-chip or a multi-chip. The memory is for storing temporary or permanent data. Besides, it has an ability of processing data conversion so as to share the processing work with its connected external CPU.

### BACKGROUND OF THE INVENTION

1. Field of the Invention

The invention relates to a memory and, more particularly, to a smart multi-functional compound memory that consists of volatile and nonvolatile memories.

2. Description of the Related Art

Generally speaking, the heart of an electronic product is a central processing unit (CPU), which coordinates the control actions of the control units, accesses data in memory, and then achieves various functions. In view of the current trend of electronic product development, a CPU has to execute synchronous or asynchronous processes that are getting more and more complicated, and the CPU also has to depend on the performance of memory to access all sorts of data. Theoretically, utilizing a higher level of CPU or a higher capacity of memory can produce electronic products that are intended for keeping up with the above-mentioned trend. But in practice, a better approach to keeping up with the trend is to reduce the workload of a CPU by enhancing the performance of memory.

### SUMMARY OF THE INVENTION

Therefore, an object of the invention is to enhance the ability of memory that supports function operations, so that memory can provide information actively rather than store information passively, in order to enhance the performance of memory.

Another object of the invention is to reduce the workload of a CPU, so as to prevent the CPU from delay processing or unstable processing.

In order to achieve the above-mentioned objects, the invention provides a smart multi-functional compound memory that includes: a first volatile memory, which is connected to an external CPU for receiving and transmitting the messages that come from the external CPU; a data conversion circuit, which is connected to the first volatile memory for converting the messages received by the first volatile memory into another kind of information; a second volatile memory, which is connected to the data conversion circuit and the external CPU for receiving the information output by the data conversion circuit, and for providing the information to the external CPU; and a nonvolatile memory, which is connected to the external CPU for providing data that can be read by the external CPU; wherein the first volatile memory, the data conversion circuit, the second volatile memory, and the nonvolatile memory are packaged on one single chip.

Preferably, information such as a waving flag, a page-skipping bookmark, a comparison classification, or an automatic feedback compensation function value is output by the above-mentioned data conversion circuit. In addition, data such as image data, music data, computer function data, game data, or compensation data is stored by the above-mentioned nonvolatile memory.

### BRIEF DESCRIPTION OF THE DRAWINGS

FIG. 1 is a diagram showing categories of volatile and nonvolatile memories;

FIG. 2 is a block diagram showing a smart multi-functional compound memory according to an embodiment of the invention; and

FIG. 3 is a diagram showing the flow of displaying font for the smart multi-functional compound memory according to the embodiment of the invention.

### DESCRIPTION OF THE PREFERRED EMBODIMENT

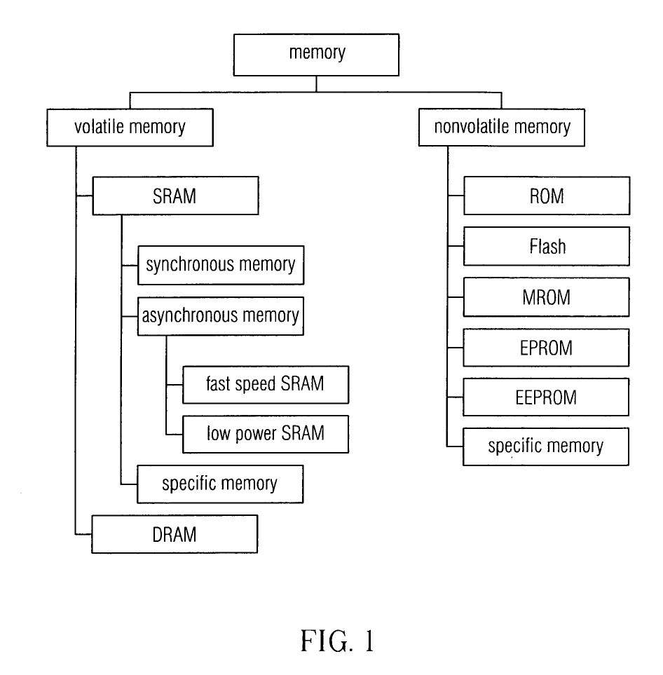

With reference to FIG. 1, memories can be divided into two categories, volatile or nonvolatile memories, wherein ROM, Flash, MROM, EPROM, EEPROM, etc. belong to the nonvolatile memory, whereas SRAM, DRAM, synchronous memory, asynchronous memory, etc. belong to the volatile memory. Memories are indispensable to various electronic products, for example, portable electronic systems such as a cellular phone or a PDA, telecommunication systems such as a value-added pager, a global position system (GPS), a set-top box, or an integrated services digital network (ISDN). Other electronic products such as an electronic dictionary, a personal organizer, and a sensor all require memories as well.

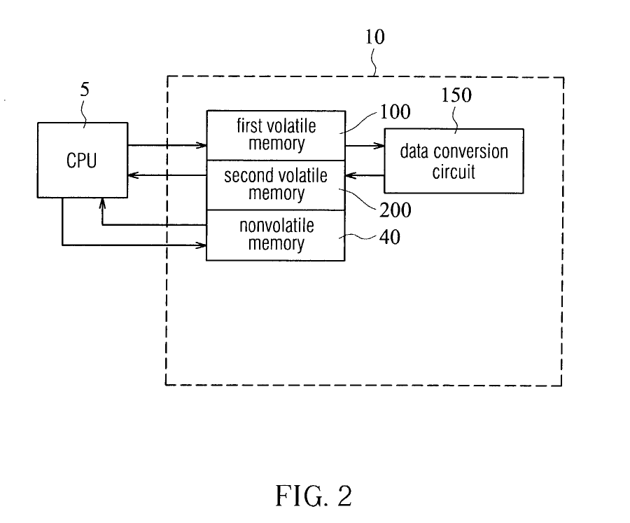

FIG. 2 is a block diagram showing a smart multi-functional compound memory according to an embodiment of the invention. The smart multi-functional compound memory 10 includes: (1) a first volatile memory 100, which is connected to an external CPU 5 for receiving and transmitting messages that come from the external CPU 5; (2) a data conversion circuit 150, which is connected to the first volatile memory 100 for converting the messages that are from the external CPU 5 and received by the first volatile memory 100 into another kind of information; (3) a second volatile memory 200, which is connected to the data conversion circuit 150 and the external CPU 5 for receiving the information that is output by the data conversion circuit 150, and for providing the information to the external CPU 5; (4) a nonvolatile memory 40, which is connected to the external CPU 5 for providing data that can be read by CPU 5; wherein the first volatile memory 100, the data conversion circuit 150, the second volatile memory 200, and the nonvolatile memory 40 are packaged on one single chip.

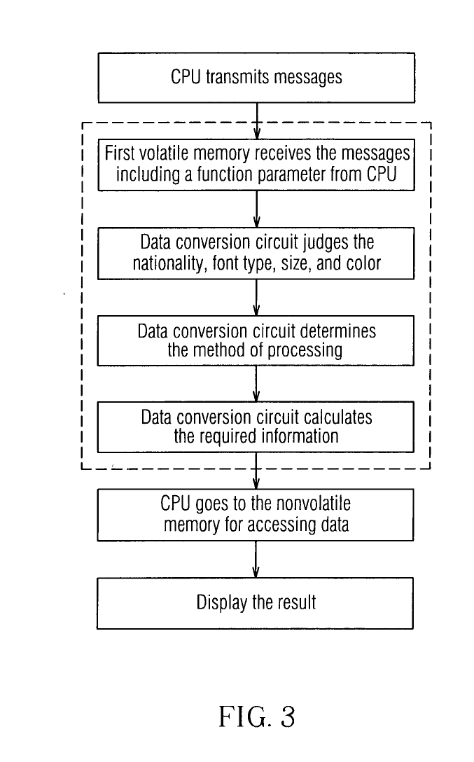

The following will describe an embodiment illustrating the functions that are supported by the smart multi-functional compound memory of the invention. First, referring to FIG. 2, the first volatile memory 100 receives messages from the external CPU 5. The messages include a certain function parameter, and are stored in the first volatile memory 100 in a certain format. Next, the messages stored in the first volatile memory 100 are transmitted to the data conversion circuit 150, which in turn converts the messages into another kind of information. For example, a certain function parameter included in a message is to display a font and two numeric data 4 and 9. As shown in FIG. 3, the flow of displaying font will be performed by the data conversion circuit 150 through executing the following steps in order: (1) judge the content of the received data, and the nationality, font type, size, and color of the font that will be shown by the data; (2) determine the method of processing; (3) calculate the required information. In the above-mentioned case, the data conversion circuit 150 also judges that the numeric data 4 and 9 should be shown by a four-bit binary format 0100 and 1001 respectively, which means both codes are in the same size but in two different nations, fonts, and colors (the third bits in both 0100 and 1001 are the same, but the first, second and fourth bits are different). Then, in the nonvolatile memory 40, the beginning address that stores the numeric data is calculated.

Afterwards, the data conversion circuit 150 processes the obtained information, and the information is transmitted to the second volatile memory 200 and stored. Finally, the external CPU 5 reads out the data in the volatile memory 40 according to the information stored in the second volatile memory 200.

In brief, the smart multi-functional compound memory 10 of the invention converts the messages from the external CPU 5 into another kind of information by utilizing the data conversion circuit 150, the first volatile memory 100, and the second volatile memory 200, and then provides the information to the external CPU 5. Therefore, the smart multi-functional compound memory 10 not only stores data passively, but also provides information to the CPU actively. Furthermore, the external CPU 5 accesses the information in the second volatile memory 200 at an appropriate time, and then reads outs the data in the nonvolatile memory 40 according to the information. By doing so, the workload of CPU 5 can be reduced, thereby avoiding delay processing or unstable processing.

More effectively, taking into account the best allocation for the circuits or the requirements for manufacturing, the first volatile memory, the second volatile memory, the data conversion circuit, and the nonvolatile memory of the smart multi-functional compound memory of the invention can be packaged as a single chip or a multi-chip. In addition, the data conversion circuit of the smart multi-functional compound memory can be configured by one or a plurality of the following circuits: a logic circuit, a pulse synthesizer, a sequential logic circuit, an arithmetic logic operation circuit, and a memory device. As to what circuits should be required for the circuit configuration, it depends on the different functions performed by different electronic products. The flow of the configured circuit is the same as the above-mentioned method of displaying font, but only the messages and the contents of the result that can be judged are different because the circuits that are used for judging can be different. Furthermore, the data stored in the nonvolatile memory can be divided into blocks such as an image data block, a music data block, a computer function data block, a game data block, and a compensation data block according to different categories of product or function, so that the nonvolatile memory can store different categories of data more systematically. Moreover, the information transmitted to the CPU by the second volatile memory is not limited to the beginning storage address of the specific data of the foregoing embodiment. For example, when a PDA utilizes the smart multi-functional compound memory, the required information that can be calculated may be a waving flag, a page-skipping bookmark, a comparison classification and so on, depending on the different processing methods decided by the memory. In the same way, when a sensor utilizes the smart multi-functional compound memory, the sensor can obtain the information of an automatic feedback compensation function value.

The foregoing is only a preferred embodiment of the invention, and the embodiment has reached an effect of being widely practiced. Any variations and modifications that come within the scope of equivalency of the claims of the invention are intended to be embraced therein.

What is claimed is:

1. A smart multi-functional compound memory comprising:
a first volatile memory, which is connected to an external CPU for receiving and transmitting messages that come from the external CPU;
a data conversion circuit, which is connected to the first volatile memory for converting the messages received by the first volatile memory into another kind of information;
a second volatile memory, which is connected to the data conversion circuit and the external CPU for receiving the information output by the data conversion circuit, and for providing the information to the external CPU; and
a nonvolatile memory, which is connected to the external CPU for providing data that can be read by the external CPU; wherein the first volatile memory, the data conversion circuit, the second volatile memory and the nonvolatile memory are packaged on one single chip.

2. The smart multi-functional compound memory as claimed in claim 1, wherein the first volatile memory consists of one or a plurality of the following memory: RAM, SRAM and DRAM.

3. The smart multi-functional compound memory as claimed in claim 1, wherein the data conversion circuit is configured by one or a plurality of the following circuits: a logic circuit, a pulse synthesizer, a sequential logic circuit, an arithmetic logic operation circuit and a memory device.

4. The smart multi-functional compound memory as claimed in claim 1, wherein the second volatile memory consists of one or a plurality of the following memory: RAM, SRAM and DRAM.

5. The smart multi-functional compound memory as claimed in claim 1, wherein the nonvolatile memory consists of one or a plurality of the following memory: ROM, MROM, EPROM, EEPROM, FLASH and readable specific memory.
